(19) United States
(12) Patent Application Publication
(10) Pub. No.: US 2023/0381930 A1
(43) Pub. Date: Nov. 30, 2023

(54) ADAPTIVE HANDWHEEL SOCKET

(71) Applicant: Ida R. Kessler, Troy, OH (US)

(72) Inventor: Ida R. Kessler, Troy, OH (US)

(21) Appl. No.: 17/664,687

(22) Filed: May 24, 2022

(51) Int. Cl. B25B 13/06; F16K 31/60

(52) U.S. Cl. CPC B25B 13/065; F16K 31/60

(57) ABSTRACT

An ergonomic rotational power transfer tool includes a unitary twisted polygonal prism having a first polygonal surface and a second polygonal surface. The first polygonal surface has a ratchet interface. The second polygonal surface is recessed to form an internal sidewall and an end wall that snugly hold a propane tank handwheel. The first and second polygonal surfaces are joined by an external sidewall having grooves that accommodate a user's fingers. This tool improves the ergonomics of the wrist by eliminating wrist flexion and extension and reducing the use of ulnar and radial deviation.

### BACKGROUND OF THE INVENTION

The present invention relates to an adaptive socket and, more particularly, to a socket for use with a propane tank handwheel.

A propane tank such as those used with gas grills generally has a small diameter handwheel. The small handwheel is generally difficult to reach and to turn with a bare hand, particularly if the user has any arthritis, weakness, or other deficits in the upper body which affects 40% of people in their lifetime.

As can be seen, there is a need for an adaptive device that makes accessing a gas grill propane tank easier for individuals with an upper body deficit.

### SUMMARY OF THE INVENTION

The present invention provides an ergonomic, adaptive socket for use with a handwheel. The socket may be used with one's hand or may be attached to a ratchet or hand drill. The socket eliminates or reduces the need for hand strength or gripping ability to turn the hand wheel on a propane tank. The inventive socket is advantageous as it accommodates hand weakness and limited mobility, promotes independence, manages and/or reduces pain, and increases safety when using a gas grill.

In addition to use at home, the inventive device may also be used for educational purposes, for occupational therapy, and for physical therapy. The inventive socket may also be used for similar small diameter handwheels on other devices.

In one aspect of the present invention, an ergonomic rotational power transfer tool comprises a unitary twisted polygonal prism having a first polygonal surface including a ratchet interface and a second polygonal surface, recessed to form an internal sidewall and an end wall configured to snugly accommodate a propane tank handwheel having a first diameter, wherein said first polygonal surface and said second polygonal surface are joined by an external sidewall having grooves configured to accommodate a user's fingers.

These and other features, aspects and advantages of the present invention will become better understood with reference to the following drawings, description, and claims.

### BRIEF DESCRIPTION OF THE DRAWINGS

FIG. 1 is a perspective view of a propane handwheel socket according to an embodiment of the present invention, shown in use;

FIG. 2 is another perspective view thereof;

FIG. 3 is another perspective view thereof;

FIG. 4 is an exploded view thereof;

FIG. 5 is a sectional view thereof, taken along line 5-5 in FIG. 1, with tank parts simplified for clarity;

FIG. 6 is a perspective view of a propane handwheel socket according to another embodiment of the present invention; and

FIG. 7 is another perspective view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is an adaptive socket for use on a propane tank handwheel. The socket generally has a twisted polygonal form which provides a better hand grip.

The inventive tool is simple to use. The user may position the socket onto the hand wheel and turn using one hand. Alternatively, the user may attach the socket to an appropriate size ratchet, with or without an extension, position the socket onto the hand wheel, and rotate the ratchet.

The use of this tool improves the ergonomics of the wrist by eliminating wrist flexion and extension and reducing the use of ulnar and radial deviation. The ergonomic tool design changes from a precision grasp (i.e., holding an object with precise opposition of tactile pads) to a power grasp (i.e., holding an object with the sides of the fingers and thumb and using the palm of the hand) to turn the handwheel of a gas grill propane tank. The use of a power grip puts less force on the smaller, more distal joints of the fingers by translating the force to the palm amid larger metacarpal phalangeal joints. This ergonomic design provides those with upper body and other physical limitations or deficits increased independence and increased safety with use of a gas grill/propane tank.

The tool or socket generally has a large outer diameter (e.g., >about 1.5″). It may be made to fit any Occupational Safety and Health Administration (OSHA) approved handwheel on a propane tank with any socket size such as about ½″ ¾″, or ⅜″. In some embodiments, the tool may have a dual-level socket operative to accommodate more than one size handwheel, including a first handwheel and a smaller handwheel, with a sidewall having a shoulder demarking a transition between the two sizes.

The method of manufacture is not particularly limited. The inventive tool is a single (i.e., unitary) piece and may be three-dimensionally (3D) printed, injection molded, etc.

The materials of manufacture are not particularly limited. The contact surface may have a variety of textures. Preferably, the socket is light weight and affordable.

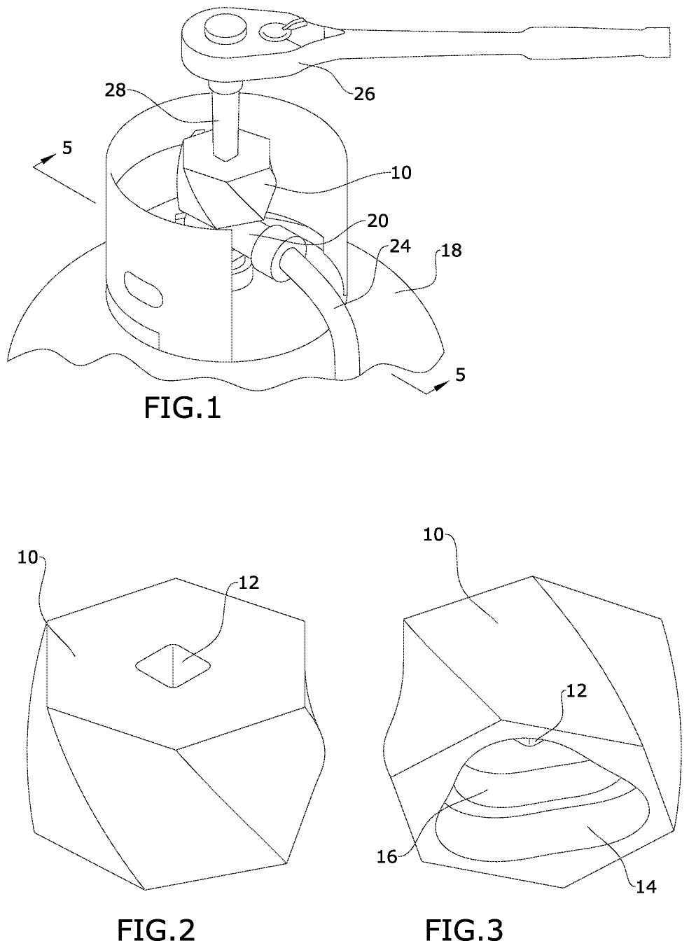

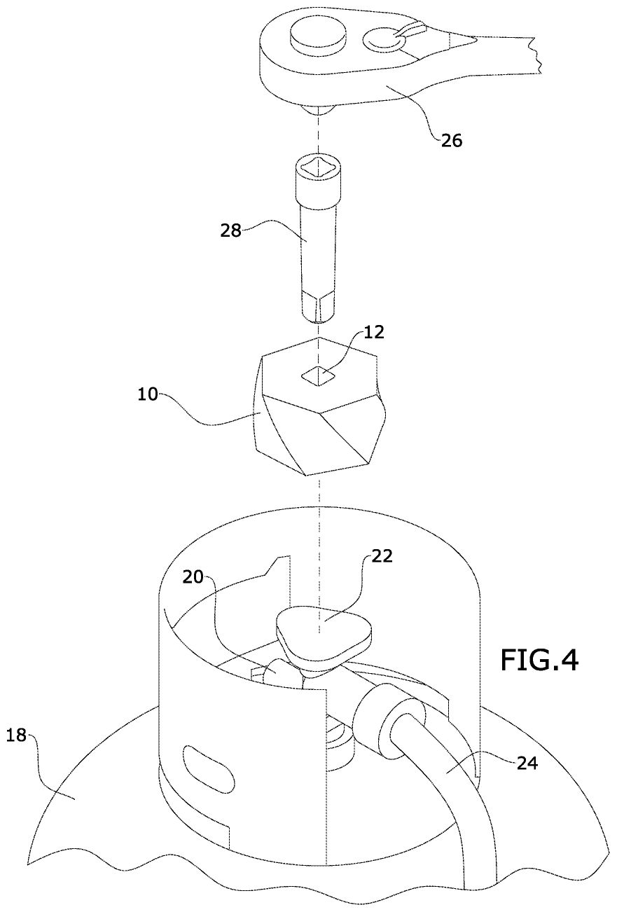

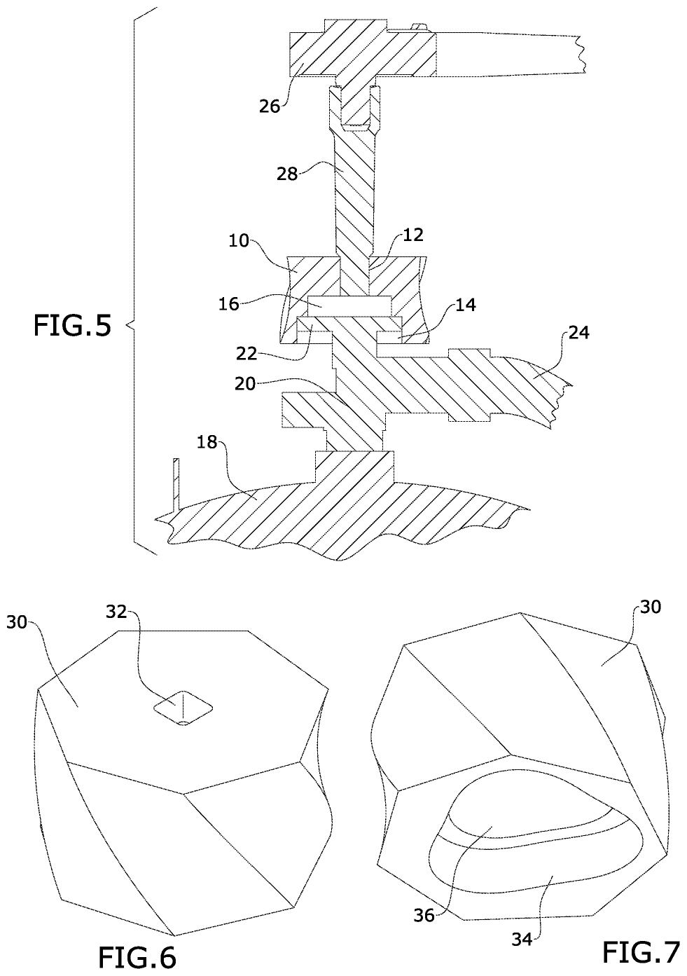

Referring to FIGS. 1 through 7, a rotational power transferring tool comprising parallel polygonal surfaces with one of the two polygons rotated at an angle n from the second polygon, i.e., a twisted polygonal prism, are shown, the transverse surfaces of which have contour grooves conforming to a user's fingers. FIG. 1 illustrates an ergonomic socket 10 having a hexagonal perimeter according to an embodiment of the present invention, shown in use on a valve 20 controlling flow in a propane tank 18 hose 24. The ergonomic socket 10 may be grasped directly with the user's hand, or as illustrated in FIG. 1, may be used with a ratchet 26 coupled with an extension 28 to turn the valve 20. As shown in FIGS. 2 and 3, the ergonomic socket 10 has a ratchet interface 12 in one surface and a dual level recess through an opposite surface, having a shoulder dividing the recess into a portion with a small handwheel socket 16 having a first diameter recessed within a portion with a large handwheel socket 14 having a second diameter larger than the first diameter. The small handwheel socket 16 and the large handwheel socket 14 have a rounded triangular mouth operative to securely couple with a handwheel 22, as shown in FIGS. 4 and 5. FIGS. 6 and 7 illustrate an ergonomic socket 30 having a heptagonal perimeter according to another embodiment of the present invention. The socket 30 has a ratchet interface 32 in a first surface and a dual level recess through an opposite surface, having a shoulder dividing the recess into a portion with a shallow large handwheel socket 34 having a first diameter and a deeper small handwheel socket 36 having a second diameter smaller than the first diameter.

It should be understood, of course, that the foregoing relates to exemplary embodiments of the invention and that modifications may be made without departing from the spirit and scope of the invention as set forth in the following claims.

What is claimed is:

1. An ergonomic rotational power transfer tool comprising:
a unitary twisted polygonal prism having a first polygonal surface including a ratchet interface and a second polygonal surface, recessed to form an internal sidewall and an end wall configured to snugly accommodate a propane tank handwheel having a first diameter, wherein said first polygonal surface and said second polygonal surface are joined by an external sidewall having grooves configured to accommodate a user's fingers.

2. The ergonomic rotational power transfer tool of claim 1, wherein the first polygonal surface and the second polygonal surface are hexagonal.

3. The ergonomic rotational power transfer tool of claim 1, wherein the first polygonal surface and the second polygonal surface are heptagonal.

4. The ergonomic rotational power transfer tool of claim 1, wherein the internal sidewall comprises a shoulder demarking a first portion configured to accommodate the propane tank handwheel having the first diameter and a second portion recessed therein configured to accommodate a smaller handwheel having a second diameter smaller than the first diameter.
